(19) United States
(12) Patent Application Publication
(10) Pub. No.: US 2018/0149059 A1
(43) Pub. Date: May 31, 2018

(54) METHOD AND SYSTEM FOR CONTROLLING A CATALYTIC CONVERTER SYSTEM

(71) Applicant: Scania CV AB, Södertälje (SE)

(72) Inventors: Magnus FRÖBERG, Hägersten (SE); Fredril ROOS, Segeltorp (SE); Magnus CARLGREN, Vagnhärad (SE)

(21) Appl. No.: 15/577,230

(22) PCT Filed: Jun. 7, 2016
(86) PCT No.: PCT/SE2016/050541

§ 371 Date: Nov. 27, 2017

(30) Foreign Application Priority Data
Jun. 11, 2015 (SE) 1150788-2

(51) Int. Cl. F01N 3/20; F01N 11/00; F01N 9/00; F02D 41/02; F02D 41/14

(52) U.S. Cl. CPC F01N 3/2066; F01N 11/005; F01N 9/005; F02D 2200/0804; F02D 41/1445; F02D 41/1446; F01N 2900/1602; F02D 41/0245

(57) ABSTRACT

The invention relates to methods, systems, and computer program products for controlling a catalytic converter system in a vehicle. The method comprises predicting the temperature of at least one element of the catalytic converter system based on at least a model of the catalytic converter and on an expected driving of the vehicle. The method further comprises controlling the input flow to the catalytic converter system based on the predicted temperature so as to optimize at least one property of the vehicle.

### CROSS-REFERENCE TO RELATED APPLICATION(S)

This application is a national stage application (filed under 35 § U.S.C. 371) of PCT/SE2016/050541, filed Jun. 7, 2016 of the same title, which, in turn claims priority to Swedish Application No. 1550788-2, filed Jun. 11, 2015 of the same title; the contents of each of which are hereby incorporated by reference.

### FIELD OF THE INVENTION

The present invention relates to systems and methods for controlling a catalytic converter system in a vehicle.

### BACKGROUND OF THE INVENTION

Vehicles use catalytic converter systems to reduce emissions from the vehicle engine, for example a diesel engine. For a catalytic converter system to work efficiently it is important that the temperature at some elements inside the catalytic converter system has some specific values, or is at least in some specific temperature range. This is due to the fact that the catalytic conversions are temperature depending. Since these temperatures often are in the range of some hundred degrees Celsius, and thus are much higher than ordinary outside temperatures, it is important to heat elements in the catalytic converter systems. One of these elements are, for example, a SCR (selective catalytic reduction) system. The heating can either be performed directly through heating elements or indirectly through the output flow of the diesel engine.

When using heating through the output flow of the diesel engine the heating effect might appear time-delayed. If it, for example, takes half a minute for the output temperature of the diesel engine to proceed in the catalytic converter system to a specific element therein, a temperature change in the output flow will affect the heating of that element only half a minute delayed.

In US 2013/0289857 it is described how an internal combustion engine comprising an exhaust system with a DOC (diesel oxidation catalyst), a DPF (diesel particle filter), and, downstream thereof a SCR catalyst can be operated. The operation of the combustion engine consists of two modes, a normal mode where emissions and fuel efficiency from the engine are optimized, and a heat-up mode which is designed to increase the temperature of the exhaust system. A thermal model taking into account the thermal inertia of the exhaust system is provided. The combustion engine is then operated in such a way that a switching between normal mode and heating up mode is provided to keep the temperature of the SCR system in a certain temperature range, taking into account the thermal model and thus the time delay in the exhaust system.

A problem with existing technology is that the heat-up period sometimes is performed although it would not have been needed, resulting in increased fuel consumption and higher emissions. This can for example happen if a higher exhaust temperature would have happened even without using the heat-up mode. Another problem with existing technology is that the normal mode sometimes is provided too long so that the temperature in the exhaust system drops below a certain value, resulting in less efficiency of the catalytic converter system and thus higher emissions, or, alternatively, into a more extreme heating and thus even higher fuel consumption to prevent a too low temperature drop in the catalytic converter system.

### SUMMARY OF THE INVENTION

An object of the present invention is to propose a novel and advantageous method for controlling a catalytic converter system for diesel engines in a vehicle.

Another object of the present invention is to propose a novel and advantageous system and a novel and advantageous computer program for controlling a catalytic converter system for diesel engines in a vehicle.

Yet another object of the invention is to propose a method, a system and a computer program which achieve an efficient and anticipatory controlling of a catalytic converter system for diesel engines in a vehicle.

Yet another object of the invention is to propose an alternative method, an alternative system and an alternative computer program for controlling a catalytic converter system for diesel engines in a vehicle.

According to an aspect of the invention there is provided a method for controlling a catalytic converter system in a vehicle. The method comprises predicting the temperature of at least one element of the catalytic converter system based on at least a model of the catalytic converter. The method further comprises controlling the input flow to the catalytic converter system based on the predicted temperature so as to optimize at least one property of the vehicle. The predicting of the temperature of said at least one element of the catalytic converter system is also based on an expected driving of the vehicle.

This has the advantage that the controlling of the input flow to the catalytic converter system will be influenced by the expected driving. This allows adapting the controlling to the expected driving, which results in that unnecessary measures can be dropped which will be anticipated by the expected driving anyhow. Examples of these anticipated measures are for example that additional heating affecting exhaust gases can be avoided when it is expected that upcoming driving anyhow will provide exhaust gases with a higher temperature. Also, countermeasures can be provided to keep elements of the catalytic converter system at the right temperature if it is foreseen that a drop in the exhaust gas temperature is expected to appear soon. Thus a better optimization can be performed.

The at least one property of the vehicle may comprise fuel efficiency and/or noxious emissions, especially tailpipe NOx-emission.

These are two crucial parameters to meet legislative regulations and to save money when operating the vehicle.

The step of controlling the input flow to the catalytic converter system may comprise choosing one out of a pre-determined set of operating modes of an engine, preferably a diesel engine, placed upstream the catalytic converter system and/or other elements placed upstream the catalytic converter system.

Choosing out of a set of pre-determined methods is a very practical way when implementing the method in a vehicle.

The method may be implemented in a vehicle comprising a diesel engine, especially in an engine control unit and/or a catalytic converter system control unit of the vehicle.

This is an easy way of achieving the advantages of the method.

The at least one element of the catalytic converter system may comprise an SCR-unit.

This is a crucial element, especially for achieving low tailpipe emissions.

The at least one element of the catalytic converter system may comprise a reductant injection system, especially the atomization section of a reductant injection system.

By including such a system an avoidance of urea crystallization, i.e. an avoidance of the formation of solid urea deposits, can be achieved with the method.

The expected driving may comprise values for an expected rotational speed of an engine and for an expected engine load.

By doing so an implementation in existing vehicles will be facilitated. This is since these quantities are relatively easy to convert into predicted quantities for the exhaust gas and thus the input flow to the catalytic converter system.

The method may use positioning information, for example map data and GPS-data, to calculate an expected driving of the vehicle.

Such information is often already available and requires thus no new components when implementing such a method in a vehicle.

The method may further comprises the step of deciding whether a special measure should be started in the catalytic converter system, where the decision is based on the predicted temperature of said at least one element of the catalytic converter system.

This might be especially useful in performing special measures only when a reasonable chance of success is to be expected. Thus, unnecessary resource using can be avoided.

According to another aspect of the invention a system for controlling a catalytic converter system in a vehicle is provided. The system comprises an engine, preferably a diesel engine. The system further comprises a catalytic converter system placed downstream the engine. The system yet even further comprises means for predicting a temperature of at least one element of the catalytic converter system. Said means for predicting a temperature is arranged to predict the temperature of said at least one element of the catalytic converter system based on at least a model of the catalytic converter system. The system also comprises means for controlling the input flow to the catalytic converter system. Said means for controlling the input flow is arranged to control the input flow based on the predicted temperature of said at least one element of the catalytic converter system so as to optimise at least one property of the vehicle. The means for predicting the temperature is arranged to predict the temperature of said at least one element of the catalytic converter system also based on an expected driving of the vehicle.

This has the advantage that the controlling of the input flow to the catalytic converter system will be influenced by the expected driving. This allows adapting the controlling to the expected driving, which results in that unnecessary measures can be dropped which will be anticipated by the expected driving anyhow. Examples of these anticipated measures are for example that additional heating affecting exhaust gases can be avoided when it is expected that upcoming driving anyhow will provide exhaust gases with a higher temperature. Also, countermeasures can be provided to keep elements of the catalytic converter system at the right temperature if it is foreseen that a drop in the exhaust gas temperature is expected to appear soon. Thus a better optimization can be performed. Further, such a system can often be implemented in existing vehicles without the need of any additional components, thus allowing easy upgrading.

The at least one property of the vehicle may comprise fuel efficiency and/or noxious emissions, especially tailpipe NOx-emission.

The means for controlling the input flow to the catalytic converter system may be arranged to control the input flow to the catalytic converter system by choosing one out of a set of operating modes of the engine and/or other elements placed upstream the catalytic converter system.

The at least one element of the catalytic converter system may comprise an SCR-unit.

The at least one element of the catalytic converter system may comprise a reductant injection system, especially the atomization section of a reductant injection system.

The expected driving may comprise values for an expected rotational speed of the engine and for an expected engine load.

Positioning information, for example map data and GPS-data, may be used in the system to calculate an expected driving of the vehicle.

The system may further comprise means for deciding whether a special measure should be started in the catalytic converter system, and where the means for deciding is arranged to base the decision on the predicted temperature of said at least one element of the catalytic converter system.

The advantages of the different examples of the method apply to the correspondent embodiment of the system.

According to an aspect of the invention a motor vehicle is provided. The motor vehicle comprises the system for controlling a catalytic converter system in a vehicle according to the present disclosure.

According to an aspect of the invention a computer program for controlling a catalytic converter system in a vehicle is provided. Said computer program comprises a program code for causing an electronic control unit or a computer connected to said electronic control unit to perform the steps according to method of the present disclosure.

According to an aspect of the invention a computer program product is provided. The computer program product comprises a program code stored on a computer readable medium for performing method steps according to the method of the present disclosure, when said program code is run on an electronic control unit or a computer connected to said electronic control unit.

Further objects, advantages and novel features of the present invention will become apparent to one skilled in the art from the following details, and also by putting the invention into practice. Whereas the invention is described below, it should be noted that it is not confined to the specific details described. One skilled in the art having access to the teachings herein will recognize further applications, modifications and incorporations in other fields, which are within the scope of the invention.

### BRIEF DESCRIPTION OF THE DRAWINGS

For fuller understanding of the present invention and its further objects and advantages, the detailed description set out below should be read in conjunction with the accompanying drawings, in which the same reference notations denote similar items in the various diagrams, and in which:

FIG. 1 schematically illustrates a vehicle according to an embodiment of the invention;

FIG. 2 schematically illustrates a system for the vehicle depicted in FIG. 1, according to an embodiment of the invention;

FIG. 3a schematically illustrates a diagram presenting a temperature curve of an element in a catalytic converter system according to an example of the invention;

FIG. 3b schematically illustrates a diagram presenting a temperature curve of an element in a catalytic converter system according to an example of the invention;

FIG. 4 is a schematic flowchart of a method according to an embodiment of the invention; and

FIG. 5 schematically illustrates a computer according to an embodiment of the invention.

### DETAILED DESCRIPTION OF THE INVENTION

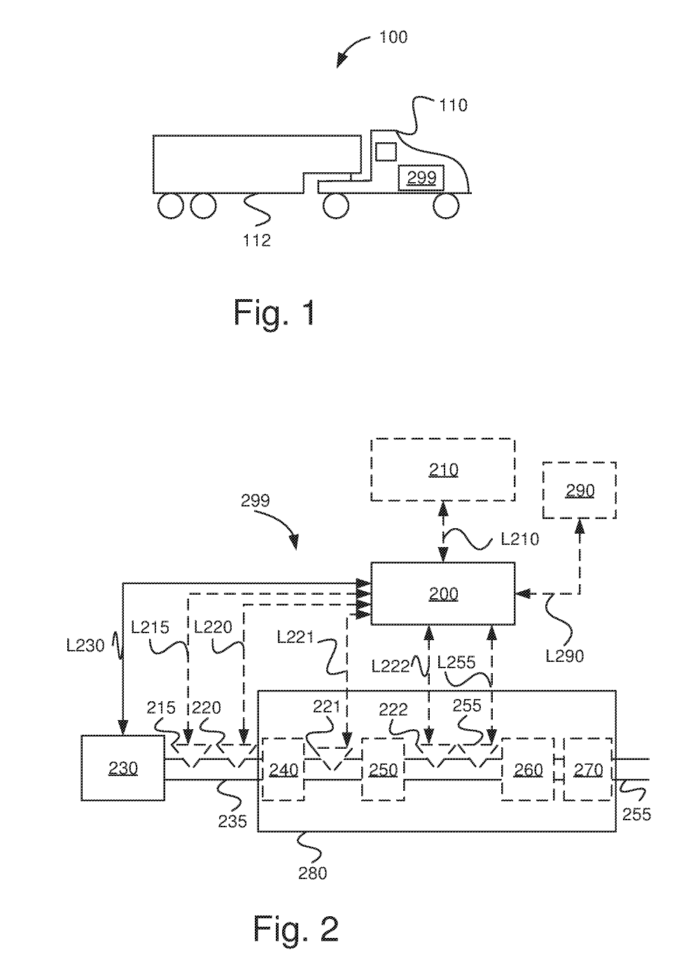

FIG. 1 depicts a side view of a vehicle 100. The exemplified vehicle 100 comprises a tractor unit 110 and a trailer 112. The vehicle may be a heavy vehicle, e.g. a truck or a bus. It may alternatively be a car.

The system for controlling a catalytic converter system in a vehicle according to the present invention might be placed inside the tractor unit 110. In one example, the embodiment of the present invention described in relation to FIG. 2 is placed inside the tractor unit 110.

It should be noted that the invention is suitable for application in any catalytic converter system and is therefore not confined to catalytic converter systems of motor vehicles. In one example the catalytic converter system is an aftertreatment system. The innovative method and the innovative system in one aspect of the invention are well suited to other platforms than motor vehicles which comprise a catalytic converter system, e.g. watercraft. The watercraft may be of any kind, e.g. motor boats, steamers, ferries or ships.

The innovative method and the innovative system are also well suited to any engine system which comprises an engine and a catalytic converter system, e.g. on a locomotive or some other platform.

The term “link” refers herein to a communication link which may be a physical connection such as an opto-electronic communication line, or a non-physical connection such as a wireless connection, e.g. a radio link or microwave link.

The term “line” refers herein to a passage for holding and conveying a fluid, e.g. a reductant in liquid form. The line may be a pipe of any desired size and be made of any suitable material, e.g. plastic, rubber or metal.

The term “reductant” or “reducing agent” refers herein to an agent used for reacting with certain emissions in an SCR system. These emissions may for example comprise NOₓ gas. The terms “reductant” and “reducing agent” are herein used synonymously. In one version, said reductant is so-called AdBlue. Other kinds of reductants may of course be used. AdBlue is herein cited as an example of a reductant, but one skilled in the art will appreciate that the innovative method and the innovative system are feasible with other types of reductants, subject to necessary adaptations in control algorithms for executing program code in accordance with the innovative method.

FIG. 2 schematically illustrates a system 299 of the vehicle 100 shown in FIG. 1, according to an embodiment of the invention. The system 299 is an embodiment of the system for controlling a catalytic converter system in a vehicle according to the present invention.

An engine 230 is during operation generating an exhaust gas flow which is lead via a first passage 235 to catalytic converter system 280. Said engine 230 may be a combustion engine. Preferably, said engine is a diesel engine. A second passage 255 is arranged to lead exhaust gas from said catalytic converter system 280 to the environment.

Said catalytic converter system 280 may comprise a DOC-unit (Diesel Oxidation Catalyst Unit) 240, a DPF-unit (Diesel Particulate Filter) 250, a SCR-unit (Selective Catalytic Reduction Unit) 260, and/or a ASC-unit (Ammonia Slip Catalyst Unit) 270. These units may be arranged downstream of said first passage 235 and upstream of said second passage 255. There might be additional passages in between said units 240, 250, 260, 270, where the additional passages connect said units 240, 250, 260, 270 and the exhaust gas is led through these additional passages. For keeping the figure clear, the additional passages are not denoted by numbers in FIG. 2.

A reductant injection system 255 might be provided upstream the SCR-unit 260, for example between the SCR-unit 260 and the DPF-unit 250. Said reductant injection system 255 can, for example, be an AdBlue dosing unit. The reductant injection system 255 may comprise an electrically operated dosing valve by means of which a flow of reductant added to the exhaust gas can be controlled. The reductant injection system 255 is arranged to supply said reducing agent to the catalytic converter system 280 of the vehicle 100. In particular the reductant injection system 255 is arranged to in a controlled way supply a suitable amount of reducing agent to the catalytic converter system 280 of the vehicle 100. The reducing agent can be supplied to the reductant injection system via a line from an AdBlue tank (not shown). The reductant injection system 255 might have an atomization section, arranged to atomize the AdBlue before adding it to the exhaust gas. In one example the atomization section is an evaporator. This atomization section might be constructed in such a way that it comprises one or more plates which could be cooled by AdBlue-drops to such an extent that these drops that there is a risk for urea crystallization, i.e. a formation of solid urea deposits. It is then important to keep the temperature of said one or more plates of the atomization section of the reductant injection system on a certain value, or at least a certain range of values, so that no urea crystallization will take place. A urea crystallization might otherwise affect the amount of AdBlue which can be injected to the exhaust gas, thus negatively affecting the performance of the SCR-unit 260.

A first control unit 200 is arranged for communication with said engine 230 via a link L230. The first control unit 200 is arranged to control operation of the engine 230 according to stored operational routines. The first control unit 200 is arranged for communication with said reductant injection system 255 via a link L255. The first control unit 200 is arranged to control operation of the reductant injection system 255 for injecting reducing agent to the exhaust gas upstream of the SCR-unit 260.

A second control unit 210 is arranged for communication with the first control unit 200 via a link L210 and may be detachably connected to it. It may be a control unit external to the vehicle 100. It may be adapted to conducting the innovative method steps according to the invention. The second control unit 210 may be arranged to perform the inventive method steps according to the invention. It may be used to cross-load software to the first control unit 200, particularly software for conducting the innovative method. It may alternatively be arranged for communication with the first control unit 200 via an internal network on board the vehicle. It may be adapted to performing substantially the same functions as the first control unit 200, such as predicting the temperature of at least one element of the catalytic converter system and controlling the input flow to the catalytic converter system. This is depicted in greater detail below. The innovative method may be conducted by the first control unit 200 or the second control unit 210, or by both of them.

In one embodiment, a first temperature sensor 220 is arranged upstream of said catalytic converter system 280. Said first temperature sensor 220 is arranged for communication with the first control unit 200 via a link L220. The first temperature sensor 220 is arranged to continuously or intermittently determine a prevailing temperature of the exhaust gas in the first passage 235. This temperature corresponds to a prevailing temperature T_{CCS} at the inlet of the catalytic converter system 280. In case the catalytic converter system 280 comprises the DOC-unit 240 the temperature corresponds to a prevailing temperature T_{DOC} of the DOC-unit 240. The temperature sensor 220 is arranged to continuously or intermittently send signals comprising information about a prevailing temperature of the exhaust gas to the first control unit 200 via the link L220. Said first control unit 200 is according to an example arranged to determine said prevailing temperature T_{CCS} or T_{DOC} at the inlet of said catalytic converter system 280, or of said DOC-unit 240, respectively, on the basis of said prevailing temperature of the exhaust gas in the first passage 235 and a prevailing exhaust gas flow according to a model stored in a memory of said first control unit 200.

In one embodiment, a second temperature sensor 221 is arranged upstream of said DPF-unit 250 and downstream of said DOC-unit 240. Said second temperature sensor 221 is arranged for communication with the first control unit 200 via a link L221. The second temperature sensor 221 is arranged to continuously or intermittently determine a prevailing temperature of the exhaust gas in the passage between the DOC-unit 240 and the DPF-unit 250. This temperature corresponds to a prevailing temperature T_{DPF} of the DPF-unit 250. The second temperature sensor 221 is arranged to continuously or intermittently send signals comprising information about a prevailing temperature of the exhaust gas to the first control unit 200 via the link L221. Said first control unit 200 is according to an example arranged to determine said prevailing temperature T_{DPF} of said DPF-unit 250, respectively, on the basis of said prevailing temperature of the exhaust gas in the passage between the DOC-unit 240 and the DPF-unit 250, and a prevailing exhaust gas flow according to a model stored in a memory of said first control unit 200.

In one embodiment, a third temperature sensor 222 is arranged upstream of said SCR-unit 260 at the passage between the DPF-unit 250 and the SCR-unit 260. Said third temperature sensor 222 is arranged for communication with the first control unit 200 via a link L222. The third temperature sensor 222 is arranged to continuously or intermittently determine a prevailing temperature of the exhaust gas in the passage between the DPF-unit 250 and the SCR-unit 260. This temperature corresponds to a prevailing temperature T_{SCR} of said SCR-unit 260. The third temperature sensor 222 is arranged to continuously or intermittently send signals comprising information about a prevailing temperature of the exhaust gas to the first control unit 200 via the link L222. Said first control unit 200 is according to an example arranged to determine said prevailing temperature T_{SCR} of said SCR-unit 260 on the basis of said prevailing temperature of the exhaust gas in the passage between the DPF-unit 250 and the SCR-unit 260 and a prevailing exhaust gas flow according to a model stored in a memory of said first control unit 200. In one example said model takes also into account the amount of injected reductant and/or the temperature of the injected reductant when calculating said prevailing temperature T_{SCR} of said SCR-unit 260. In the shown example said third temperature sensor 222 is placed upstream of the reductant injection system 255. The third temperature sensor could, however, in another example, also be placed downstream of the reductant injection system 255.

According to one embodiment, an exhaust gas influencing unit 215 is provided at the first passage 235. Said exhaust gas influencing unit 215 is arranged for communication with the first control unit 200 via a link L215. The exhaust gas influencing unit 215 is placed downstream of the engine 230 and upstream of the catalytic converter system 280. In the shown example the exhaust gas influencing unit 215 is placed upstream of the first temperature sensor 220. In one example the exhaust gas influencing unit 215 is an exhaust brake. The exhaust brake can be arranged to influence the flow of exhaust gas. If the exhaust brake is fully open, the exhaust gas might pass basically unaffected. If the exhaust brake is partly closed, there will be a hinder for the exhaust gas to pass. In an extreme case this exhaust brake can be closed nearly in total. The partly or nearly fully closing of the exhaust brake will cause the engine 230 to use more fuel to support the same engine load compared to a fully open exhaust brake. Using more fuel in the engine will cause the exhaust gas to get a higher temperature. An increased temperature of the exhaust gas will lead to an increased temperature in the catalytic converter system 280. This is since the exhaust gas will pass through the catalytic converter system 280, interact with it, and thereby transfer some of its heat energy to the catalytic converter system 280

In another example the exhaust gas influencing unit 215 is an additional fuel injector which injects fuel, for example diesel, into the first passage 235. In one example the exhaust gas influencing unit 215 is both an exhaust brake and an additional fuel injector. The exhaust gas influencing unit can also be any other unit which can influence the exhaust gas. This influencing is, for example, causing a change in temperature of the exhaust gas, causing a change of the amount of exhaust gas which passes through the first passage 235, and/or causing a change in the composition of the exhaust gas in the first passage 235.

According to an example there is provided a temperature sensor (not shown) for measuring a prevailing temperature T of said SCR-unit 260 which sensor is arranged at said SCR-unit 260. Said temperature sensor is arranged to continuously or intermittently determine a prevailing temperature T of said SCR-unit 260 and continuously or intermittently send signals comprising information thereof to the first control unit 200 via a suitable link (not shown).

The first control unit 200 may according to an embodiment be arranged to by means of a stored model calculate a prevailing temperature of the exhaust gas in the first passage 235. The first control unit 200 may be arranged to on the basis of information about for example into said engine 230 injected amount of fuel and exhaust gas mass flow calculate a prevailing temperature of the exhaust gas in the first passage 235. The first control unit 200 may be arranged to on the basis of information of how an optional wastegate (not shown) is operated calculate a prevailing temperature of the exhaust gas in the first passage 235. The first control unit 200 may be arranged to on the basis of information of how the exhaust gas influencing unit 215 is operated calculate a prevailing temperature of the exhaust gas in the first passage 235.

A sensor (not shown) for measuring a prevailing air mass flow on an inlet side of the engine 230 may be provided. Said air mass flow sensor is arranged to continuously or intermittently determine a prevailing air mass flow and continuously or intermittently send signals comprising information thereof to the first control unit 200 via a suitable link (not shown). Hereby said first control unit 200 is arranged to determine a prevailing exhaust gas flow on the basis of said signals and information about prevailing fuel supply to the engine 230.

The first control unit 200 may according to one embodiment be arranged to by means of a stored model calculate a prevailing exhaust gas mass flow in the first passage 235. The first control unit 200 is arranged to, on the basis of information about for example operation state of said combustion engine 230, calculate a prevailing exhaust gas mass flow in said first passage 235. Said first control unit 200 may also be arranged to determine a prevailing exhaust gas flow in the first passage 235 on the basis of how the optional wastegate is operated and/or how the exhaust gas influencing unit 215 is operated.

The first control unit 200 is arranged for predicting a temperature of the catalytic converter system 280, or at least one element of the catalytic converter system 280. This prediction is at least based on a model of the catalytic converter system 280. The model can, for example, include one or more elements of the catalytic converter system 280, such as the DOC-unit 240, the DPF-unit 250, the reductant injection system 255, the SCR-unit 260 and/or the ASC-unit 270. The model can also include how said one or more elements of the catalytic converter system 280 are affected by the exhaust gas. This affection might, for example, relate to the time delay which it takes for a temperature change in the exhaust gas to proceed to said one or more elements of the catalytic converter system 280. This affection might also relate to the heat transfer between the exhaust gas and said one or more elements. The prediction of the temperature of said catalytic converter system 280, or at least one element of the catalytic converter system 280, can also be based on the prevailing temperature in the first passage 235 and/or on the gas mass flow in the first passage 235. It should be noted that the mass flow of the exhaust gas usually proceeds through the catalytic converter system 280 on a much faster time scale than temperature changes which the exhaust gas imposes to the catalytic converter system.

The first control unit 200 is also arranged to predict the temperature of said at least one element of the catalytic converter system 280 based on an expected driving of the vehicle. In one example, the system 299 comprises means for providing information relating to expected driving 290. Said means for providing information relating to expected driving 290 are arranged for communication with the first control unit 200 via a link L290. Said means for providing information relating to expected driving 290 are arranged for providing information relating to an expected driving of the vehicle. In one example the means 290 comprise a GPS (global positioning system) unit. The means 290 might also comprise map unit providing map data and/or a navigation system. The means 290 might comprise one or more sensors for determining information relating to an expected driving of the vehicle. In one example the means 290 belong to a so-called look-ahead system. The means 290 are arranged to send information relating to expected driving to the first control unit 200 via the link L290.

The first control unit 200 is arranged to calculate an expected driving of the vehicle. This expected driving could for example comprise an expected rotational speed and an expected engine load for the engine 230. This expected rotational speed and said expected engine load can, for example, be calculated based on a current position of the vehicle and based on an expected an expected driving path of the vehicle. This expected driving path can, for example, include road conditions and/or topography data. As an example, knowing the desired speed of the vehicle, the road topography and other parameters of the vehicle and/or the surrounding of the vehicle it is possible to calculate an expected rotational speed and an expected engine load of the engine 230 to achieve the desired speed on said road topography. How this can be done is known in the art. The term road topography can, for example, relate to the gradient of the road and/or the surface material of the road. Also any other data relating to an expected driving can be used.

In one example, the expected driving is calculated based on positioning information. In one example this positioning information is a relative position on an often repeated route. This can, for example, be a certain distance from the starting bus stop on a bus route for a bus driving this road repeatedly. The first control unit 200 stores in one example values of the rotational speed of the engine and the engine load for many distance positions after the first bus stop on a route. This can for example be done in a memory of the first control unit 200. These values are averaged over many runs on that bus route. Thus, knowing said certain distance from the starting point will allow the first control unit 200 to know the forthcoming values for the rotational speed of the engine and the engine load.

The above are only some possible examples of how an expected driving of the vehicle can be determined. The invention is not limited to the above examples but can be used with any kind of determining or knowing the expected driving of the vehicle.

The first control unit 200 is further arranged to control the input flow to the catalytic converter system 280. The term input flow relates to properties of the exhaust gas in the first passage 235. The term input flow can thus, for example, relate to the mass flow of the exhaust gas, to the temperature of the exhaust gas, to the chemical components, to the composition of the exhaust gas or to any other property of the exhaust gas. In one example, the input flow is controlled by controlling the exhaust gas influencing unit 215. In one example, the input flow is controlled by controlling the engine 230. Properties of the engine which might be controlled for affecting the input flow to the catalytic converter system 280 are, for example, the operation of the wastegate, the input flow to the engine, the amount and/or time of injecting fuel to the engine, or the like.

The first control unit 200 is arranged to control the input flow based on the predicted temperature of said at least one element of the catalytic converter system 280 so as to optimize at least one property of the vehicle. This at least one property of the vehicle can, for example, be the fuel efficiency and/or noxious emissions from the vehicle. In one example the noxious emissions refer to tailpipe NOₓ-emissions. This control can, for example, comprise assuring that the prevailing temperature of the SCR-unit 260 always is above a certain threshold, or in a certain temperature range. This assures providing a reaction rate inside the SCR-unit 260 which is sufficient to follow maximal allowed emission rates. Another example of control is to keep a sufficiently high temperature in the reductant injection system 255 for not causing urea crystallization. Further examples of controlling the input flow for optimizing at least one property of the vehicle are keeping a sufficiently high temperature and/or a sufficient amount of HC in the exhaust gas to allow regeneration in the DPF-unit 250.

The first control unit 200 can also be arranged to decide whether a special measure should be started in the catalytic converter system 280. The control unit 200 is then arranged to base the decision on the predicted temperature of said at least one element of the catalytic converter system 280. In one example the special measure comprises a regeneration of the DPF-unit 250. This generation requires a high temperature in the DPF-unit 250. This regeneration also generally requires a high temperature in the DOC-unit 240 over a long time, for example over a period of several minutes. This is to assure that the DOC-unit 240 can oxidize extra injected diesel in the first passage 235, where the extra injected diesel is needed to increase the temperature to the high temperature needed in the DPF-unit. The first control unit 200 can then, in case the predicted temperature of the DOC-unit 240 will be above a certain threshold for a certain amount of time, decide to inject the extra diesel, to achieve the high temperature in the DPF-unit 250. In case it is predicted that the predicted temperature in the DOC-unit 240 will not be above the threshold for a long enough time period to achieve the high temperature in the DPF-unit 250 needed for regeneration, the extra injection of diesel can be omitted, thus saving fuel.

In one example, the first control unit 200 is arranged to control the input flow to the catalytic converter system 280 by choosing one out of a set of operating modes of the engine 230 and/or other elements placed upstream the catalytic converter system 280. In one example there can be two such operating modes, for example one ordinary operating mode and one heating mode. The heating mode can then be used so that a minimum temperature is always assured in at least one element of the catalytic converter system 280.

In another example, at least three such operating modes are present. These can, for example, comprise an ordinary operating mode, a heating mode, and a strong heating mode. The ordinary operating mode can, for example, be a method where a exhaust brake is fully opened and the engine 230 thus can be controlled in a fuel saving way. The heating mode can, for example, be a mode where the wastegate is opened, thus increasing fuel consumed in the engine for achieving the same load, but also achieving a higher temperature of the exhaust gas in the first passage 235. The strong heating mode can, for example, be a mode where the exhaust brake is nearly fully closed, thus drastically increasing fuel consumption, but also drastically increasing the temperature in the exhaust gas in the first passage 235. The at least three operating modes can then in one example be chosen in such a way so as to optimize the fuel efficiency and/or the conversion efficiency of the catalytic converter system 280. How this can be done in practice is described in more detail in relation to the following figures.

In the above example the first control unit 200 has been described as means for predicting a temperature of at least one element of the catalytic converter system 280, as means for controlling the input flow to the catalytic converter system 280 and as possible means for deciding whether a special measure should be started in the catalytic converter system 280. In another embodiment (not shown in the figure) said means are embodied by different elements. For example the means for predicting a temperature of at least one element of the catalytic converter system 280 can be different from the means for controlling the input flow to the catalytic converter system 280. In that case these two different means will be arranged to communicate so that the means for predicting a temperature of at least one element of the catalytic converter system 280 can transmit information regarding the predicted temperature to the means for controlling the input flow to the catalytic converter system 280. Consequently, many other possible embodiments of the means could be used as well.

It shall also be stressed that the embodiment shown in FIG. 2 comprises several possible temperature sensors 220, 221, 222. These temperature sensors are described before. However, none of the temperature sensors 220, 221, 222 is mandatory since controlling the input flow to the catalytic converter system 280, thus knowing the input flow to the catalytic converter system 280, and having a model of the catalytic converter system 280 is enough to know the temperature of the elements in the catalytic converter system 280.

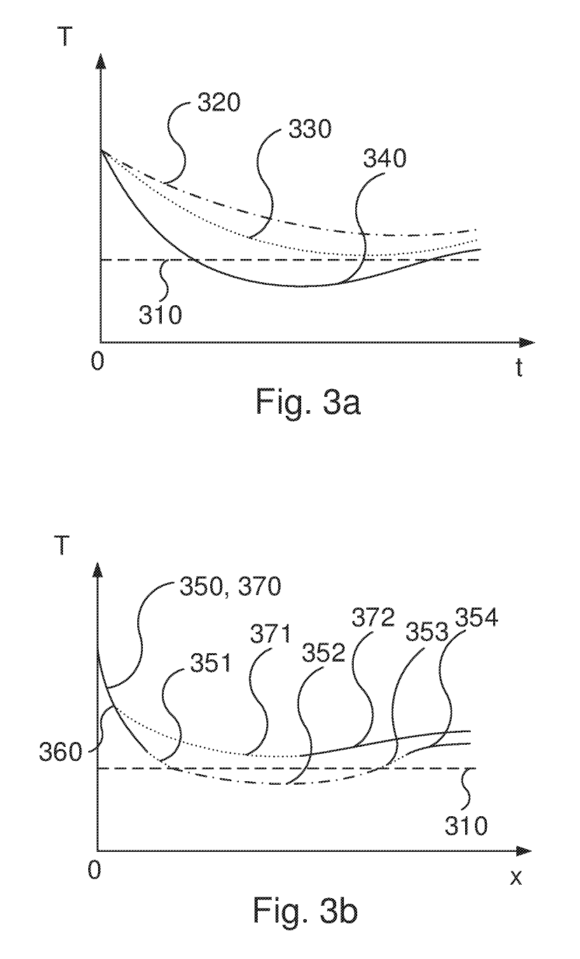

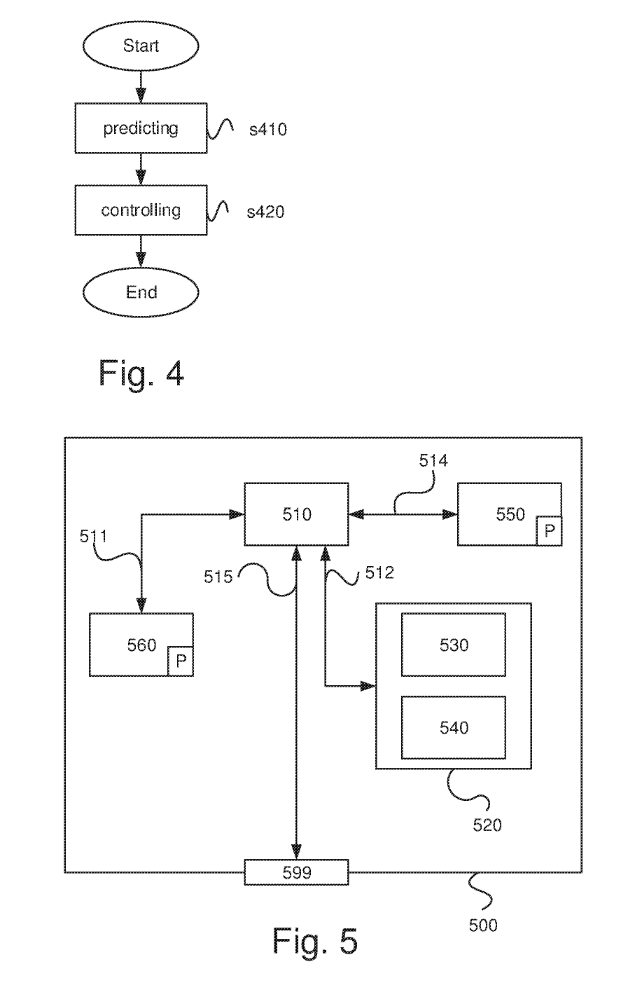

The method for controlling a catalytic converter system in a vehicle will now be described in connection with FIGS. 3 and 4. FIG. 3a schematically illustrates a diagram presenting a temperature curve of an element in a catalytic converter system 280 according to an example of the invention. On one axis the temperate T of one element of the catalytic converter system 280 is shown, whereas the other axis shows the time t starting from the present time, depicted by 0. Temperature curves of three different modes 320, 330, 340 are present in FIG. 3a. The temperature curves of the three different modes 320, 330, 340 can, for example, be a temperature curve of an ordinary mode 340, a temperature curve of a heating mode 330, and a temperature curve of a strong heating mode 320. An example of such modes has been described above. The shown temperature curves are temperature curves of the predicted temperature of the least one element of the catalytic converter system 280, where the prediction is based on at least a model of the catalytic converter and on an expected driving of the vehicle. The threshold value 310 is a minimum temperature threshold which has to be achieved, for example a minimum temperature threshold for the SCR-unit which has to be kept to achieve enough conversion so as to comply with a maximum allowed amount of noxious emission. This has been described in more detail above.

As can be seen from FIG. 3a, the predicted temperature curve of the ordinary mode 340 will not be able to keep the minimum threshold 310 value for an element of the catalytic converter system 280. As can be also seen from FIG. 3a, the temperature curve of the heating mode 330 will always keep the temperature of the element of the catalytic converter system 280 above the threshold 310. The temperature curve of the strong heating mode 320 will also always keep the temperature of the element of the catalytic converter system 280 above the threshold 310. However, as has been described before, the strong heating mode has a higher fuel consumption than the heating mode. Given the predicted temperature curves 320, 330, 340 the input flow to the catalytic converter system 280 can thus in one embodiment be operated based on the predicted temperature so that the heating mode is chosen. This is in one example done by opening the wastegate as has been described before. By doing so an optimization both on fuel efficiency and on noxious emissions has been performed. If the strong heating mode would have been chosen the fuel consumption would have been higher than needed. If the ordinary mode would have been chosen, too high noxious emissions would have been occurred.

The three different temperature curves 320, 330, 340 are here only illustrated for one starting point in time. In practice one might do a new prediction at a later time, for example one or five seconds later. This new prediction will then provide new temperature curves. Based on these new temperature curves one might then decide to choose a different operating mode. This is due to the fact that another operating mode later on might be preferable when optimizing noxious emissions and fuel consumption. This might for example be the case if the new prediction shows that already the ordinary operating mode is enough to keep the temperature of the element of the catalytic converter system above the threshold 310.

Another example is depicted in FIG. 3b, which schematically illustrates a diagram presenting a temperature curve of an element in a catalytic converter system 280 according to an example of the invention. Contrary to FIG. 3a one axis now shows a position x instead of a time t. The position x does in one example refer to a position of a bus on a route, where the value 0 refers to the current position and any other value x to the distance on the route from the current position. This route can for example be a route which the bus repeatedly drives, for example a specific bus route.

In this example the line 310 shows the threshold temperature for an element of the catalytic converter system 280 as described in connection with FIG. 3a. The continuous lines 350, 370, 354, 372 refer in this example to the ordinary operation mode which has been described above. The dotted lines 371, 351, 353 refer to the heating mode which has been described above. The dash-dotted line 352 refers to the strong heating mode which has been described above. A lower temperature curve consisting of the sections 350, 351, 352, 353 and 354 shows the temperature curve of the element of the catalytic converter system 280 as a function of said position x from the last time the bus was driving the route. Alternatively, the lower temperature curve shows the temperature curve of the element of the catalytic converter system 280 averaged over a number of drives on the route. As can be seen, the lower temperature curve started with the section 350 where the ordinary operating mode was used. Then, the heating mode was used as indicated by section 351. When the temperature dropped under the threshold 310 the strong heating mode was used as indicated by section 352. As the temperature got over the threshold 310, the heating mode was used again, as illustrated by section 353, followed by normal operating mode as illustrated by section 354. As can be seen, this driving cycle was not optimal since both the temperature dropped under the threshold 310 and the strong heating mode had to be used during a longer time period, leading to high fuel consumption. Knowing this history, it can be used as an expected driving to predict the temperature of the at least one element of the catalytic converter system 280. As a result, it can be realized that one has to switch earlier to the heating mode to have a chance to avoid a temperature drop under the threshold 310. This is illustrated by the upper temperature curve consisting of sections 370, 371 and 371. Section 370 is the same as section 350 until the switching point 360. At the switching point 360 the heating mode is started, illustrated by section 371. Switching to the heating mode earlier than previous might thus avoid getting under the threshold 310 and after some time one can switch back to the ordinary operating mode illustrated by section 372. As a result, no drop below the threshold has occurred, thus keeping noxious emissions to an acceptable level. Further, it was not needed to use the strong heating mode, thus saving fuel consumption.

The above example can also relate to other repeatedly driven routes and need by no means be limited to bus routes. Shipping companies or truck companies might have vehicles going repeatedly on the same routes. Also ferries or other boat lines might operate on the same routes. One realization might be performed via map data and GPS-data. Then, GPS-data tells where on a route the vehicle is situated. Another example is that only other positioning information, for example the value of a kilometre counter is used to determine where on a route a vehicle is situated. Assuming always using the same route this gives as well a well-defined relative position which can be used for the invention to work.

It should be noted that averaging over a number of runs on the route has the strong advantage that bus stops, traffic lights, speed regulations, water streams for boats/ferries, or the like, will be used automatically when determining an expected driving, without any need to model them.

FIG. 4 shows a schematic flowchart of a method according to an embodiment of the invention.

The method starts with step s410 of predicting the temperature of at least one element of the catalytic converter system based on at least a model of the catalytic converter. The predicting of the temperature of said at least one element of the catalytic converter system is also based on an expected driving of the vehicle. Said expected driving comprises in one example values for expected rotational speed of an engine and for an expected engine load. Said expected driving is, in one example, calculated by using positioning information, for example map data and GPS-data. Examples of this have been described before. When predicting the temperature, the prediction is in one example performed for a time-period of more than thirty seconds, starting from the present time, preferably around two minutes starting from the present time. After step s410 a consecutive step s420 is performed.

In step s420 the input flow to the catalytic converter system is controlled based on the predicted temperature so as to optimize at least one property of the vehicle. The step s420 of controlling the input flow to the catalytic converter system can comprise choosing one out of a pre-determined set of operating modes of an engine, preferably a diesel engine, placed upstream the catalytic converter system and/or other elements placed upstream the catalytic converter system. Examples of these modes have been given above in relation to FIG. 2-3. In one example the operating modes of the engine placed upstream the catalytic converter system and/or other elements placed upstream the catalytic converter system relate to different heating in the catalytic converter system. After step s420 the method ends.

In one example, the method further comprises the step of deciding whether a special measure should be started in the catalytic converter system. This step is not shown in FIG. 4. Said deciding is based on the predicted temperature of said at least one element of the catalytic converter system. Such a special measure is in one example a regeneration of a DPF-unit. When making such a decision, one can also predict the temperature for a longer time period, for example 30 minutes. This longer time period is preferably at least as long as the special measure needs to be performed.

In one example the method is performed repeatedly, for example once a second or once every five seconds.

In one example, the method is implemented in the vehicle comprising a diesel engine, especially in an engine control unit and/or a catalytic converter system control unit of the vehicle. The predicting and controlling can for example be performed by the first control unit 200. Said at least one property of the vehicle comprises in one example fuel efficiency and/or noxious emissions, especially tailpipe NOₓ-emission. The optimization can comprise that a specific quantity has to be above or below a certain threshold, or at a specific value range. The optimization can comprise that a specific quantity has to be optimized under constraints for another quantity. Another example of an optimization constraint is that urea crystallisation has to be avoided.

FIG. 5 is a diagram of one version of a device 500. The control units 200 and 210 described with reference to FIG. 2 may in one version comprise the device 500. The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

The computer program comprises routines for controlling one or several of the elements depicted in relation to FIG. 2. Especially the computer program comprises routines for controlling the engine 230 and/or elements placed in the first passage 235 between the engine and the catalytic converter system 280. The computer program can also comprise routines for controlling the catalytic converter system 280 or elements thereof.

The computer program P comprises routines for predicting the temperature of at least one element of the catalytic converter system based on at least a model of the catalytic converter and on an expected driving of the vehicle. The computer program P comprises routines for controlling the input flow to the catalytic converter system based on the predicted temperature so as to optimize at least one property of the vehicle.

The computer program P may comprise routines for deciding whether a special measure should be started in the catalytic converter system, where the decision is based on the predicted temperature of said at least one element of the catalytic converter system.

The program P may be stored in an executable form or in compressed form in a memory 560 and/or in a read/write memory 550.

Where it is stated that the data processing unit 510 performs a certain function, it means that it conducts a certain part of the program which is stored in the memory 560 or a certain part of the program which is stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit via a data bus 511. The read/write memory 550 is arranged to communicate with the data processing unit 510 via a data bus 514. The links L210, L215, L220, L221, L222, L230, L233, L255, and L290, for example, may be connected to the data port 599 (see FIG. 2).

When data are received on the data port 599, they are stored temporarily in the second memory element 540. When input data received have been temporarily stored, the data processing unit 510 will be prepared to conduct code execution as described above. According to one embodiment signals received on the data port 599 comprise information about a prevailing air mass flow into said engine 230, a prevailing temperature of said exhaust gas and/or a prevailing temperature T_{SCR} of said SCR-unit 260. The signals might also comprise positioning data, for example map-data and/or GPS-data.

Parts of the methods herein described may be conducted by the device 500 by means of the data processing unit 510 which runs the program stored in the memory 560 or the read/write memory 550. The memory 560 or the read/write memory 550 might store a model of the catalytic converter system 280. When the device 500 runs the program, methods herein described are executed.

The foregoing description of the preferred embodiments of the present invention is provided for illustrative and descriptive purposes. It is not intended to be exhaustive, nor to limit the invention to the variants described. Many modifications and variations will obviously suggest themselves to one skilled in the art. The embodiments have been chosen and described in order to best explain the principles of the invention and their practical applications and thereby make it possible for one skilled in the art to understand the invention for different embodiments and with the various modifications appropriate to the intended use.

1. A method for controlling a catalytic converter system in a vehicle, the method comprising:
predicting the temperature of at least one element of the catalytic converter system based on at least a model of the catalytic converter and on an expected driving of the vehicle; and
controlling an input flow to the catalytic converter system based on the predicted temperature so as to optimize at least one property of the vehicle.

2. The method according to claim 1, wherein the at least one property of the vehicle comprises fuel efficiency and/or noxious emissions.

3. The method according to claim 1, wherein the step of controlling the input flow to the catalytic converter system comprises choosing one out of a pre-determined set of operating modes of an engine placed upstream of the catalytic converter system and/or other elements placed upstream of the catalytic converter system.

4. The method according to claim 1, wherein the method is implemented in the vehicle comprising a diesel engine.

5. The method according to claim 1, wherein the at least one element of the catalytic converter system comprises a selective catalytic reduction unit.

6. The method according to claim 1, wherein the at least one element of the catalytic converter system comprises a reductant injection system.

7. The method according to claim 1, wherein the expected driving comprises values for an expected rotational speed of an engine and for an expected engine load.

8. The method according to claim 1, wherein positioning information is used to calculate an expected driving of the vehicle.

9. The method according to claim 1, further comprising the step of deciding whether a special measure should be started in the catalytic converter system, where the decision is based on the predicted temperature of said at least one element of the catalytic converter system.

10. A system for controlling a catalytic converter system in a vehicle, the system comprising:
an engine;
a catalytic converter system placed downstream of the engine;
means for predicting a temperature of at least one element of the catalytic converter system, where said means for predicting a temperature is arranged to predict the temperature of said at least one element of the catalytic converter system based on at least a model of the catalytic converter system and on an expected driving of the vehicle; and
means for controlling an input flow to the catalytic converter system, where said means for controlling the input flow is arranged to control the input flow based on the predicted temperature of said at least one element of the catalytic converter system so as to optimize at least one property of the vehicle.

11. The system according to claim 10, wherein the at least one property of the vehicle comprises fuel efficiency and/or noxious emissions.

12. The system according to claim 10, wherein the means for controlling the input flow to the catalytic converter system is arranged to control the input flow to the catalytic converter system by choosing one out of a set of operating modes of the engine and/or other elements placed upstream of the catalytic converter system.

13. The system according to claim 10, wherein the at least one element of the catalytic converter system comprises a selective catalytic reduction unit.

14. The system according to claim 10, wherein the at least one element of the catalytic converter system comprises a reductant injection system.

15. The system according to claim 10, wherein the expected driving comprises values for an expected rotational speed of the engine and for an expected engine load.

16. The system according to claim 10, wherein positioning information is used to calculate an expected driving of the vehicle.

17. The system according to claim 10, wherein the system further comprising means for deciding whether a special measure should be started in the catalytic converter system and where the means for deciding is arranged to base the decision on the predicted temperature of said at least one element of the catalytic converter system.

18. A motor vehicle comprising a system for controlling a catalytic converter system in the vehicle, said system comprising:
an engine;
a catalytic converter system placed downstream of the engine;
means for predicting a temperature of at least one element of the catalytic converter system, where said means for predicting a temperature is arranged to predict the temperature of said at least one element of the catalytic converter system based on at least a model of the catalytic converter system and on an expected driving of the vehicle; and
means for controlling an input flow to the catalytic converter system, where said means for controlling the input flow is arranged to control the input flow based on the predicted temperature of said at least one element of the catalytic converter system so as to optimize at least one property of the vehicle.

19. (canceled)

20. A computer program product comprising a program code stored on a non-transitory computer readable medium for controlling a catalytic converter system in a vehicle, said computer program code comprising computer instructions to cause one or more computer processors to perform the following operations:
predicting the temperature of at least one element of the catalytic converter system based on at least a model of the catalytic converter and on an expected driving of the vehicle; and
controlling an input flow to the catalytic converter system based on the predicted temperature so as to optimize at least one property of the vehicle.
